(19) United States
(12) Patent Application Publication
(10) Pub. No.: US 2017/0213138 A1
(43) Pub. Date: Jul. 27, 2017

(54) DETERMINING USER SENTIMENT IN CHAT DATA

(71) Applicant: Machine Zone, Inc., Palo Alto, CA (US)

(72) Inventors: Nikhil Bojja, Mountain View, CA (US); Shivasankari Kannan, Sunnyvale, CA (US); Satheeshkumar Karuppusamy, San Jose, CA (US)

(21) Appl. No.: 15/007,639

(22) Filed: Jan. 27, 2016

(51) Int. Cl. G06N 5/04; G06N 7/00; G06N 99/00

(52) U.S. Cl. CPC G06N 5/04; G06N 99/005; G06N 7/005

(57) ABSTRACT

Methods, systems, and apparatus, including computer programs encoded on a computer storage medium, for receiving a message authored by a user, determining, using a first classifier, that the message contains at least a first word describing positive or negative sentiment and, based thereon, extracting, using a first feature extractor, one or more features of the message, wherein each feature comprises a respective word or phrase in the message and a respective weight signifying a degree of positive or negative sentiment, and determining, using a second classifier that uses the extracted features as input, a score describing a degree of positive or negative sentiment of the message, wherein the first feature extractor was trained with a set of training messages that each was labeled as having positive or negative sentiment.

### BACKGROUND

This specification relates to natural language processing, and more particularly, to determining user sentiment in chat messages.

Generally speaking, online chat is a conversation among participants who exchange messages transmitted over the Internet. A participant can join in a chat session from a user interface of a client software application (e.g., web browser, messaging application) and send and receive messages to and from other participants in the chat session.

A sentence such as a chat message can contain sentiment expressed by the sentence's author. Sentiment of the sentence can be a positive or negative view, attitude, or opinion of the author. For instance, “I'm happy!,” “This is great” and “Thank a lot!” can indicate positive sentiment. “This is awful,” “Not feeling good” and “*sigh*” can indicate negative sentiment. A sentence may not contain sentiment. For instance, “It's eleven o'clock” may not indicate existence of sentiment.

### SUMMARY

In general, one aspect of the subject matter described in this specification can be embodied in methods that include the actions of performing by one or more computers, receiving a message authored by a user, determining, using a first classifier, that the message can contain at least a first word describing positive or negative sentiment and, based thereon, extracting, using a first feature extractor, one or more features of the message, wherein each feature can comprise a respective word or phrase in the message and a respective weight signifying a degree of positive or negative sentiment, and determining, using a second classifier that can use the extracted features as input, a score describing a degree of positive or negative sentiment of the message, wherein the first feature extractor was trained with a set of training messages that each was labeled as having positive or negative sentiment. Other embodiments of this aspect include corresponding systems, apparatus, and computer programs.

These and other aspects can optionally include one or more of the following features. The second classifier was trained with features extracted by the first feature extractor from the set of training messages. The first word can be an emoticon, emoji, a word having a particular character in the word's correct spelling form that is repeated consecutively one or more times, an abbreviated or shortened word, or a text string with two or more consecutive symbols. The first feature extractor can be an artificial neural network feature extractor. The second classifier can be a naive Bayes classifier, random forest classifier, or support vector machines classifier. Extracting one or more features of the message can further comprise extracting, using a second feature extractor, one or more features of the message wherein each of the extracted features can comprise: (i) two or more consecutive words that describe positive or negative sentiment, (ii) a count of words, symbols, biased words, emojis, or emoticons, (iii) a word having a particular character in the word's correct spelling form that is repeated consecutively one or more times, or (iv) a distance between a conditional word and second word describing positive or negative sentiment.

Particular implementations of the subject matter described in this specification can be implemented to realize one or more of the following advantages. The system described herein receives a message authored by a user and determine sentiment of the message. The system first identifies whether the message contains sentiment by determining in the message a word describing positive or negative sentiment. The system then extracts features from the message using a machine learning model trained by training messages such as chat messages that were labeled as having positive or negative sentiment. More particularly, each extracted feature includes a word in the message and its similarity to words in the training messages. The system then classifies the message as having positive or negative sentiment based on the extracted features of the message. The system classifies the message by using another machine learning model that was trained by extracted features from the training message.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for message translation.

FIG. 2 is a flowchart of an example method for determining sentiment in a message.

FIG. 3 is a flowchart of another example method for determining sentiment in a message.

Like reference numbers and designations in the various drawings indicate like elements.

### DETAILED DESCRIPTION

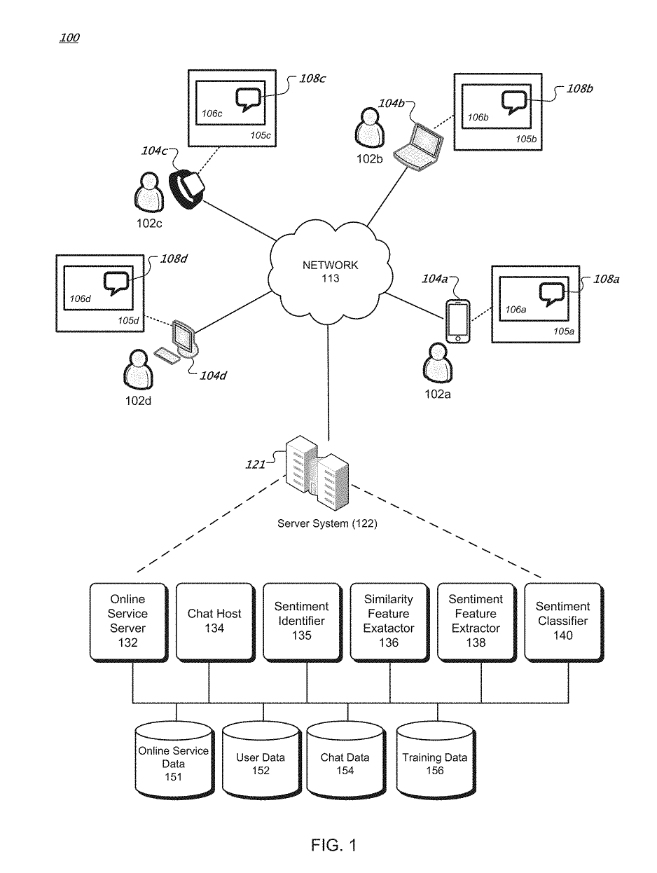

FIG. 1 illustrates an example system 100 for message translation. In FIG. 1, a server system 122 provides functionality for message translation. Generally speaking, a message is a sequence of characters and/or media content such as images, sounds, video. For example, a message can be a word or a phrase. A message can include digits, symbols, Unicode emoticons, emojis, images, sounds, video, and so on. The server system 122 comprises software components and databases that can be deployed at one or more data centers 121 in one or more geographic locations, for example. The server system 122 software components comprise an online service server 132, chat host 134, sentiment identifier 135, similarity feature extractor 136, sentiment feature extractor 138, and sentiment classifier 140. The server system 122 databases comprise an online service data database 151, user data database 152, chat data database 154, and training data database 156. The databases can reside in one or more physical storage systems. The software components and databases will be further described below.

In FIG. 1, the online service server 132 is a server system that hosts one or more online services such as websites, email service, social network, or online games. The online service server 132 can store data of an online service (e.g., web pages, emails, user posts, or game states and players of an online game) in the online service data database 151. The online service server 132 can also store data of an online service user such as an identifier and language setting in the user data database 152.

In FIG. 1, a client device (e.g., 104a, 104b, and so on) of a user (e.g., 102a, 102b, and so on) can connect to the server system 122 through one or more data communication networks 113 such as the Internet, for example. A client device as used herein can be a smart phone, a smart watch, a tablet computer, a personal computer, a game console, or an in-car media system. Other examples of client devices are possible. Each user can send messages to other users through a graphical user interface (e.g., 106a, 106b, and so on) of a client software application (e.g., 105a, 105b, and so on) running on the user's client device. The client software application can be a web browser or a special-purpose software application such as a game or messaging application. Other types of a client software application for accessing online services hosted by the online service server 132 are possible. The graphical user interface (e.g., 106a, 106b, and so on) can comprise a chat user interface (e.g., 108a, 108b, and so on). By way of illustration, a user (e.g., 102a), while playing an online game hosted by the online service server 132, can interact (“chat”) with other users (e.g., 102b, 102d) of the online game by joining a chat session of the game, and sending and receiving messages in the chat user interface (e.g., 108a) in the game's user interface (e.g., 106a).

The chat host 134 is a software component that establishes and maintains chat sessions between users of online services hosted by the online service server 132. The chat host 134 can receive a message sent from a user (e.g., 102d) and send the message to one or more recipients (e.g., 102a, 102c), and store the message in the chat data database 154. The chat host 134 can provide message translation functionality. For instance, if a sender and a recipient of a message have different message settings (e.g., stored in the user data database 152), the chat host 134 can first translate the message from the sender's language to the recipient's language, then send the translated message to the recipient. The chat host 134 can translate a message from one language to another language using one or more translation methods, for example, by accessing a translation software program via an application programming interface or API. Examples of machine translation methods include rules (e.g., linguistic rules) and dictionary based machine translation, and statistical machine translation. A statistical machine translation can be based on a statistical model that predicts a probability of a text string in one language (“target”) is a translation from another text string in another language (“source”).

It can be desirable to determine sentiment (or lack thereof) of chat messages, for example, for marketing or customer service purposes. However, determining sentiment of a chat message can be difficult as chat messages are often short and lack of sufficient context. Chat messages can often contain spelling errors, or chatspeak words (e.g., slang, abbreviation, or a combination of alphabets, digits, symbols, or emojis) that are specific to a particular environment (e.g., text messaging, or a particular online service).

Particular implementations described herein describe methods for determining sentiment in messages such as chat messages. For a message, various implementations first determine whether the message contains sentiment. If the message contains sentiment, a feature extractor is used to extract features from the message. Each feature comprises a word or phrase in the message and a weight indicating a degree of positive or negative sentiment. More particularly, the feature extractor is trained with training messages that each was labeled as having positive or negative sentiment. A sentiment classifier then uses the extracted features as input and determines a score describing a degree of positive or negative sentiment of the message, as described further below.

In FIG. 1, the sentiment identifier 135 is a software component that classifies whether a message contains sentiment or not. A message can comprise of one or more words, for example. Each word in the message can be a character string (e.g., including letters, digits, symbols, Unicode emoticons, or emojis) separated by spaces or other delimiters (e.g., punctuation marks) in the message. In addition to words and delimiters, a message can also contain media such as images, sounds, video, and so on. The media can be interspersed with the words or attached to the message apart from the words. The sentiment identifier 135 identifies a message as containing sentiment if it determines that the message contains at least one word indicating a positive or negative sentiment. For instance, words describing positive sentiment can include happy, amazing, great, peace, wow, and thank. Words describing negative sentiment can include sad, sigh, crazy, low, sore, and weak. Other examples of words describing positive or negative sentiment are possible. For instance, a word describing positive or negative sentiment can be a Unicode emotion or emoji. As for another example, a word describing positive or negative sentiment can include a character from the word's correct spelling repeated more than one time such as “pleeeease” (an exaggerated form of “please”). A word describing positive or negative sentiment can be an abbreviated or shortened version of the word (e.g., “kickn” or “kickin” for “kicking). A word describing positive or negative sentiment can be a text string including two or more consecutive symbols or punctuation marks such as “!!,” “???,” and “!@#$.” A word describing positive or negative sentiment can be a chatspeak word (e.g., slang, abbreviated or shortened word, or a combination of alphabets, digits, symbols, or emojis).

The similarity feature extractor 136 is a software component that extracts features from a message, after the sentiment identifier 135 classifies the message as containing sentiment. Each feature includes a word in the message and a weight describing a degree of sentiment of the word. A feature can also include a phrase (e.g., two or more consecutive words) in the message and a weight describing a degree of sentiment of the phrase. The degree of sentiment can be a real number between +1 and −1, for example. A positive number (e.g., 0.7) can indicate positive sentiment, and a negative number (e.g., −0.4) can indicate negative sentiment. A more positive number (but less than or equal to +1) indicates a higher degree of positive sentiment. A more negative number (but greater than or equal to −1) indicates a higher degree of negative sentiment. For instance, a feature (of a message) can be a word “good” (or a phrase “nice and easy”) and its degree of sentiment of 0.5, indicating positive sentiment. A feature can be a word “excellent” (or a phrase “outstanding effort”) and its degree of sentiment of 0.8, indicating a higher degree of positive sentiment than the positive sentiment of the word “good” (or the phrase “nice and easy”). A feature can be a word “nah” (or a phrase “so so”) and its degree of sentiment of −0.2, indicating negative sentiment. A feature can be a word “sad” (or a phrase “down in dumps”) and its degree of sentiment of −0.7, indicating a higher degree of negative sentiment than the negative sentiment of the word “nah” (or the phrase “so so”).

The similarity feature extractor 136 can use a machine learning model to extract features from a message. The machine learning model can be trained on a set of training messages, for example. The set of training messages can be a set of chat messages (e.g., 10,000 chat messages from the chat data database 154) that is each labeled (e.g., with a flag) as having positive or negative sentiment, for example. For instance, a training message such as “It's a sunny day,” “let's go,” or “cool, dude” can be labeled as having positive sentiment. A training message such as “no good,” “it's gloomy outside,” or “:-(” can be labeled as having negative sentiment. A training message can be labeled as having no sentiment. For instance, a training message such as “It's ten after nine” or “turn right after you pass the gas station” can be labeled as having no sentiment. The set of training messages can be stored in the training data database 156, for example. In various implementations, numerical values can be used to label a training message as having positive, negative, or no sentiment. For instance, +1, 0, and −1 can be used to label a training message as having positive sentiment, no sentiment, and negative sentiment, respectively. As for another example, +2, +1, 0, −1, −2 can be used to label a training message as having extremely positive sentiment, positive sentiment, no sentiment, negative sentiment, and extremely negative sentiment, respectively.

In this way, the similarity feature extractor 136 can extract from a message a particular feature associated with a particular word or phrase in the message and respective degree of sentiment, based on the learning from the training messages. More particularly, the degree of sentiment can represent how similar a particular word in the message is to words in the training messages that were each labeled as having positive or negative sentiment.

By way of illustration, assume that a vector can be a numerical representation of a word, phrase, message (sentence), or a document. For instance, a message m1 “Can one desire too much a good thing?” and message m2 “Good night, good night! Parting can be such a sweet thing” can be arranged in a matrix in a feature space (can, one, desire, too, much, a, good, thing, night, parting, be, such, sweet) as follows:

| | m1 | m2 |
|---|---|---|
| can | 1 | 1 |
| one | 1 | 0 |
| desire | 1 | 0 |
| too | 1 | 0 |
| much | 1 | 0 |
| a | 1 | 1 |
| good | 1 | 2 |
| thing | 1 | 1 |
| night | 0 | 2 |
| parting | 0 | 1 |
| be | 0 | 1 |
| such | 0 | 1 |
| sweet | 0 | 1 |

In this example, a magnitude of a particular word in a vector above corresponds to a number of occurrences of the particular word in a message. For instance, the word “good” in the message m1 can be represented by a vector [00000010000000]. The word “good” in the message m2 can be represented by a vector [0000002000000]. The word “night” in the message m1 can be represented by a vector [0000000000000]. The word “night” in the message m2 can be represented by a vector [0000000020000]. The message m1 can be represented by a vector [1111111100000]. The message m2 can be represented by a vector [1000012121111]. Other representations of messages (or documents) using word vectors are possible. For instance, a message can be represented by an average of vectors (a “mean representation vector”) of all the words in the message, instead of a summation of all words in the message.

A degree of sentiment extracted by the similarity feature extractor 136 can correspond to a cosine distance or cosine similarity between a vector A representing a particular word and another vector B representing words in the training messages that were labeled as having positive or negative sentiment:

cosine similarity=A·B/(∥a∥∥B∥)

The cosine similarity is the dot product of the vectors A and B divided by the respective magnitude of the vectors A and B. That is, the cosine similarity is the dot product of A's unit vector (A/∥A∥) and B's unit vector (B/∥B∥). The vectors A and B are vectors in a feature space where each dimension corresponds to a word in the training messages. For instance, assuming that the vector B represents a cluster of words that are in the training messages labeled as having positive sentiment. A positive cosine similarity value close to +1 indicates that the particular word has higher degree of positive sentiment in that the particular word is very similar (in the feature space) to the words in the training messages labeled as having positive sentiment. A positive but close to 0 value indicates that the particular word has lower degree of positive sentiment in that the particular word is less similar (in the feature space) to the words in the training message labeled as having positive sentiment. In like manners, assuming that the vector B represents a cluster words that are in the training messages labeled as having negative sentiment. A positive cosine similarity value close to +1 indicates that the particular word has higher degree of negative sentiment in that the particular word is very similar (in the feature space) to the words in the training messages labeled as having negative sentiment. A positive but close to 0 value indicates that the particular word has lower degree of negative sentiment in that the particular word is less similar (in the feature space) to the words in the training messages labeled as having negative sentiment. Other representation of similarity between a particular word or phrase in a message and words in the training messages are possible.

The similarity feature extractor 136 can use an artificial neural network model as the machine learning model and train the artificial neural network model with the set of training messages, for example. Other machine learning models for extracting features from a message are possible. The artificial neural network model includes a network of interconnected nodes, for example. Each node can include one or more inputs and an output. Each input can be assigned with a respective weight that adjusts (e.g., amplify or attenuate) an effect of the input. The node can compute the output based on the inputs (e.g., calculate the output as a weighted sum of all inputs). The artificial neural network model can include several layers of nodes. The first layer of nodes take input from a message, and provides output as input to the second layer of nodes, which in turn provide output to the next layer of nodes, and so on. The last layer of nodes provide output of the artificial neural network model in features associated with words from the message and respective degree of sentiment as described earlier. The similarity feature extractor 136 can run (e.g., perform operations of) an algorithm implementing the artificial neural network model with the set of training messages (each can be represented as a vector in a feature space and labeled as having positive or negative sentiment as input to the algorithm). The similarity feature extractor 136 can run (i.e., train) the algorithm until weights of the nodes in the artificial neural network model are determined, for example, when a value of each weight converges with a specified threshold after iterations minimizing a cost function such as a mean-squared error function. For instance, a mean-squared error function can be an average of a summation of respective squares of estimated errors of the weights.

The sentiment classifier 140 is a software component that uses features extracted from a message by the similarity feature extractor 136 as input, and determines a score of degree of positive or negative sentiment of the message. A score (e.g., a floating point number) of degree of sentiment can be between −1 and 1, for example, with a positive score indicating the message having positive sentiment, and a negative score indicating the message having negative sentiment. For instance, the sentiment classifier 140 can determine a score of −0.6 for a text string “this is not good,” and a score of +0.9 for another text string “excellent!!!.” In various implementations, degree of positive or negative sentiment of a message can be expressed as classes or categories of positive or negative sentiment. For instance, categories of sentiment can be “very positive,” “positive,” none,” “negative,” and “very negative.” Each category can correspond to a range of the score determined by the sentiment classifier 140, for example.

More particularly, the sentiment classifier 140 can be a machine learning model that is trained on features extracted by the similarity feature extractor 136 from the same set of training messages that were used to train the similarity feature extractor 136. The machine learning model for the sentiment classifier 140 can be a random forest model, naive Bayes model, or support vector machine model. Other machine learning models for the sentiment classifier 140 are possible.

The random forest model includes a set (an “ensemble”) of decision trees. Each decision tree can be a tree graph structure with nodes expanding from a root node. Each node can make a decision on (predict) a target value with a given attribute. An attribute (decided upon by a node) can be a word pattern (e.g., a word with all upper-case letters, all digits and symbols, or mix with letters and digits), word type (e.g., a negation word, interjection word), Unicode emoticon or emoji, chatspeak word, elongated word (e.g., “pleeeease”), or a continuous sequence of n item (n-gram). Other attributes are possible. Attributes determined by each decision tree of the set of decision trees are randomly distributed. The sentiment classifier 140 can perform an algorithm implementing the random forest model with the training features as input to the algorithm. As described earlier, the training features were extracted by the similarity feature extractor 136 from the same set of training messages that were used to train the similarity feature extractor 136. The sentiment classifier 140 can run (i.e., train) the algorithm to determine decision tree structures of the model using heuristic methods such as a greedy algorithm.

The naive Bayes model calculates a probability of a particular label or category y as a function p of a plurality (d) of features (xᵢ) as follows:

p(y,x₁,x₂, . . . ,x_{d})=q(y)Πqⱼ(xⱼ|y)

Here, a label y can be a category of sentiment such as “positive sentiment” or “negative sentiment.” xⱼ can be a feature extracted by the similarity feature extractor 136 described earlier. q(y) is a parameter or probability of seeing the label y. qⱼ(xⱼ|y) is a parameter or conditional probability of xⱼ given the label y. The sentiment classifier 140 can perform an algorithm to implement the naive Bayes model with the training features. As described earlier, the training features were extracted by the similarity feature extractor 136 from the same set of training messages that were used to train the similarity feature extractor 136. The sentiment classifier 140 can run (i.e., train) the algorithm to determine the parameters in the model through iteration until a value of each parameter converges to a specified threshold, for example.

The support vector machine model solves an optimization problem as follows:

minimize:½W^{T}W+CΣξᵢ

subjectto:yᵢ(W^{T}φ(xᵢ)+b)≧1−ξᵢ, and ξᵢ≧0

Here, yᵢ are labels or categories such as “positive sentiment” or “negative sentiment.” xⱼ are a feature extracted by the similarity feature extractor 136 described earlier. W is a set of weight vectors (e.g., normal vectors) that can describe hyperplanes separating features of different labels. The sentiment classifier 140 can perform an algorithm implementing the support vector machine model with the training features. As described earlier, the training features were extracted by the similarity feature extractor 136 from the same set of training messages that were used to train the similarity feature extractor 136. The sentiment classifier 140 can run (i.e., train) the algorithm to solve the optimization problem (e.g., determining the hyperplanes) using a gradient descent method, for example.

In addition to using features of a message extracted by the similarity feature extractor 136 as input in determining sentiment of the message, the sentiment classifier 140 can use other features extracted from the message to determine sentiment of the message. The sentiment feature extractor 138 is a software component that extracts sentiment features of a message. The sentiment feature extractor 138 can extract features of a message based on a count of words, symbols, biased words (e.g., negative words), Unicode emoticons, or emojis in the message, for example. Other features are possible. For instance, the sentiment feature extractor 138 can extract features of a message based on a distance (e.g., word count) in the message between a conditional word (e.g., should, may, would) or intensifier (e.g., very, fully, so), and another word describing positive or negative sentiment (e.g., good, happy, sad, lousy). The sentiment feature extractor 138 can extract features of a message based on consecutive words in the message (e.g., in consecutive words or m-gram) that describe positive or negative sentiment (e.g., “not good,” “holy cow” or “in no way”). The sentiment feature extractor 138 can extract features of a message based on a word in the message that a character in the word's correct spelling is repeated more than one time (e.g., “greeeeat” as an exaggerated form of “great”). In various implementations, a feature extracted by the sentiment feature extractor 138 can include a word or phrase and a weight (a number) indicating a degree of sentiment.

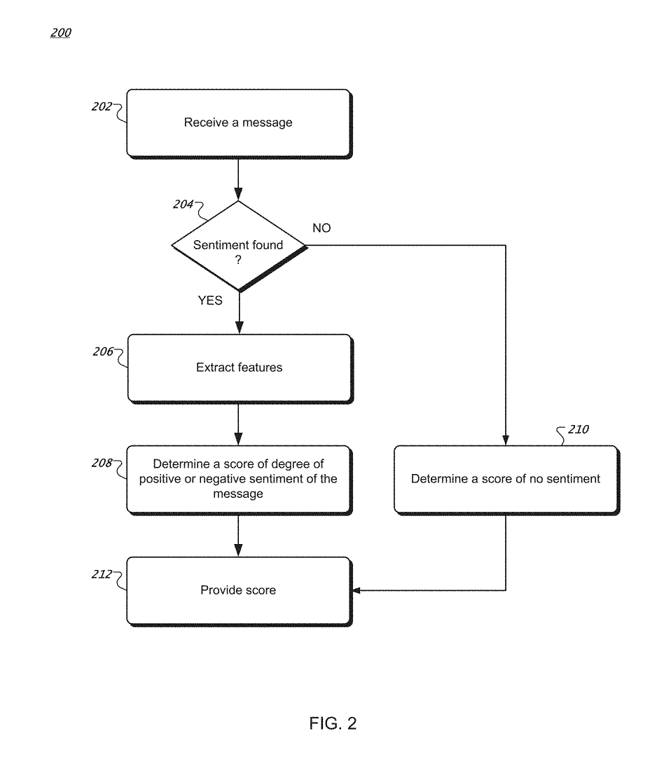

The server system 122 can determine sentiment in messages such as chat messages using the feature extractors and sentiment classifier described above. FIG. 2 is a flow chart of an example method for determining sentiment in a message. For example, the chat host 134 can receive a message (Step 202). The sentiment identifier 135 determines whether the message contains sentiment (Step 204). As described earlier, the sentiment identifier 135 can determine that the message contains sentiment if the message contains at least a word describing positive or negative sentiment. If positive or negative sentiment is found in the message, the similarity feature extractor 136 and the sentiment feature extractor 138 can extract one or more features from the message (Step 206). The sentiment classifier 140 then determines a score of degree of positive or negative sentiment based on the features extracted by the similarity feature extractor 136 and the sentiment feature extractor 138 (Step 208). The sentiment classifier 140 then provides the score to the server system 122 (Step 212). For instance, the sentiment classifier 140 can provide the score to a survey software component of the server system 122. The survey software component can post a survey question to the message's author if the score exceeds a threshold value (e.g., greater than 0.8 or less than −0.8). If the sentiment identifier 135 determines that the message does not contain sentiment, the sentiment identifier 135 can determine a score (e.g., 0) for the message, indicating that no sentiment is in the message (210). The sentiment identifier 135 can provide the score to the survey software component, for example.

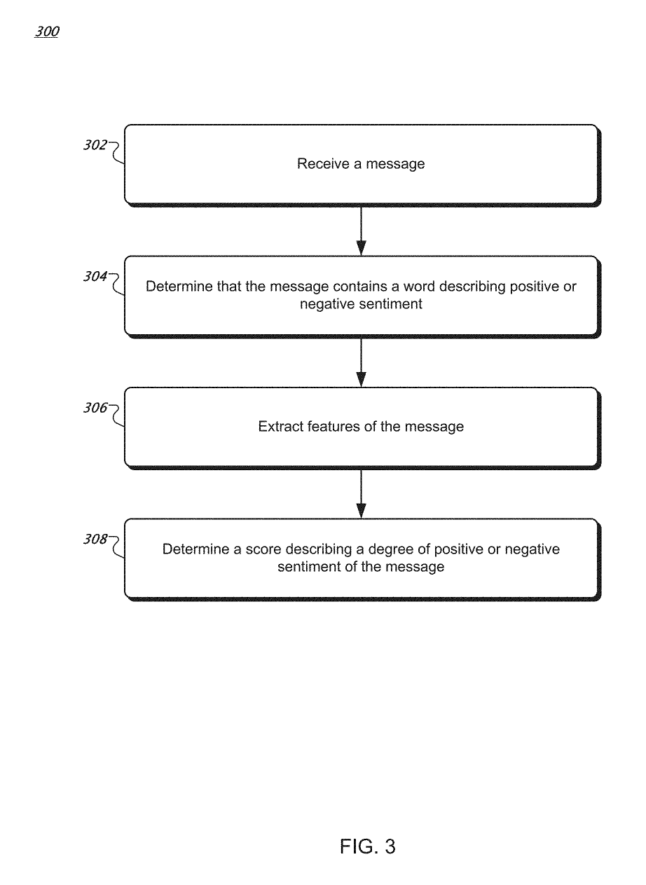

FIG. 3 is a flowchart of another example method for determining sentiment in a message. The method can be implemented using software components of the server system 122, for example. The method begins by receiving a message authored by a user (Step 302; e.g., chat host 134). The method determines, using a first classifier (e.g., sentiment identifier 135), that the message contains at least a first word describing positive or negative sentiment (Step 304). If the message contains a word describing positive or negative sentiment, the method extracts, using a first feature extractor (e.g., similarity feature extractor 136), one or more features of the message (Step 306). Each extracted feature comprises a respective word in the message and a respective weight signifying a degree of positive or negative sentiment. The method determines, using a second classifier (e.g., sentiment classifier 140) that uses the extracted features as input, a score describing a degree of positive or negative sentiment of the text string (Step 308). Note that the first feature extractor was trained with a set of training messages that each was labeled as having positive or negative sentiment.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a smart phone, a smart watch, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD) (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
extracting, using a first feature extractor, one or more first features from a message, wherein each first feature comprises a respective word or phrase in the message and an associated weight signifying a degree of positive or negative sentiment;
extracting, using a second feature extractor, one or more second features from the message, wherein each second feature comprises a distance between a first word and a second word in the message, wherein the first word comprises at least one of a conditional word and an intensifier word, and wherein the second word comprises at least one of a positive sentiment and a negative sentiment; and
determining a score describing a degree of positive or negative sentiment of the message based on output of a trained classifier, wherein the extracted first and second features are provided as input to the classifier.

2. The method of claim 1, wherein the classifier was trained with features extracted by the first and second feature extractors from a set of training messages.

3. The method of claim 1, wherein the first feature comprises an emoticon, an emoji, a word having a particular character in a correct spelling form of the word that is repeated consecutively one or more times, a phrase, an abbreviated or shortened word, or a text string with two or more consecutive symbols.

4. The method of claim 1, wherein extracting, using the first feature extractor, one or more first features from the message comprises using an artificial neural network feature extractor to extract the features.

5. The method of claim 1, wherein the classifier comprises a naive Bayes classifier, a random forest classifier, or a support vector machine classifier.

6. The method of claim 1, further comprising:
extracting, using a third feature extractor, one or more third features of the message, wherein each of the extracted third features comprises:
(i) two or more consecutive words that describe positive or negative sentiment;
(ii) a count of words, symbols, biased words, emojis, or emoticons; or
(iii) a word having a particular character in the word's correct spelling form that is repeated consecutively one or more times.

7. A system comprising:
one or more computers programmed to perform operations comprising:
extracting, using a first feature extractor, one or more first features from a message, wherein each first feature comprises a respective word or phrase in the message and an associated weight signifying a degree of positive or negative sentiment;
extracting, using a second feature extractor, one or more second features from the message, wherein each second feature comprises a distance between a first word and a second word in the message, wherein the first word comprises at least one of a conditional word and an intensifier word, and wherein the second word comprises at least one of a positive sentiment and a negative sentiment; and
determining a score describing a degree of positive or negative sentiment of the message based on output of a trained classifier, wherein the extracted first and second features are provided as input to the classifier.

8. The system of claim 7, wherein the classifier was trained with features extracted by the first and second feature extractors from a set of training messages.

9. The system of claim 7, wherein the first feature comprises an emoticon, an emoji, a word having a particular character in a correct spelling form of the word that is repeated consecutively one or more times, a phrase, an abbreviated or shorted word, or a text string with two or more consecutive symbols.

10. The system of claim 7, wherein extracting, using the first feature extractor, one or more first features from the message comprises using an artificial neural network feature extractor to extract the features.

11. The system of claim 7, wherein the classifier comprises a naive Bayes classifier, a random forest classifier, or a support vector machines classifier.

12. The system of claim 7, wherein the operations further comprising:
extracting, using a third feature extractor, one or more third features of the message, wherein each of the extracted third features comprises:
(i) two or more consecutive words that describe positive or negative sentiment;
(ii) a count of words, symbols, biased words, emojis, or emoticons; or
(iii) a word having a particular character in the word's correct spelling form that is repeated consecutively one or more times.

13. An article comprising:
a non-transitory computer storage medium having instructions stored thereon that when executed by one or more computers cause the computers to perform operations comprising:
extracting, using a first feature extractor, one or more first features from a message, wherein each first feature comprises a respective word or phrase in the message and an associated weight signifying a degree of positive or negative sentiment;
extracting, using a second feature extractor, one or more second features from the message, wherein each second feature comprises a distance between a first word and a second word in the message, wherein the first word comprises at least one of a conditional word and an intensifier word, and wherein the second word comprises at least one of a positive sentiment and a negative sentiment; and
determining a score describing a degree of positive or negative sentiment of the message based on output of a trained classifier, wherein the extracted first and second features are provided as input to the classifier.

14. The article of claim 13, wherein the classifier was trained with features extracted by the first and second feature extractors from a set of training messages.

15. The article of claim 13, wherein the first feature comprises an emoticon, an emoji, a word having a particular character in a correct spelling form of the word that is repeated consecutively one or more times, a phrase, an abbreviated or shorted word, or a text string with two or more consecutive symbols.

16. The article of claim 13, wherein extracting, using the first feature extractor, one or more first features from the message comprises using an artificial neural network feature extractor to extract the features.

17. The article of claim 13, wherein the classifier comprises a naive Bayes classifier, a random forest classifier, or a support vector machines classifier.

18. The article of claim 13, wherein the operations further comprise:
extracting, using a third feature extractor, one or more third features of the message, wherein each of the extracted third features comprises:
(i) two or more consecutive words that describe positive or negative sentiment;
(ii) a count of words, symbols, biased words, emojis, or emoticons; or
(iii) a word having a particular character in the word's correct spelling form that is repeated consecutively one or more times.

19. The method of claim 1, wherein the first word comprises the intensifier word.

20. The system of claim 7, wherein the first word comprises the intensifier word.
